(19) United States
(12) Patent Application Publication
(10) Pub. No.: US 2010/0156012 A1
(43) Pub. Date: Jun. 24, 2010

(54) HYDRO-PNEUMATIC SUSPENSION SYSTEM

(76) Inventors: Sean Timoney, Dublin (IE); Colin James Anderson, Kells (IE)

Correspondence Address: BIRCH STEWART KOLASCH & BIRCH, PO BOX 747, FALLS CHURCH, VA, 22040-0747, US

(21) Appl. No.: 12/509,058

(22) Filed: Jul. 24, 2009

Related U.S. Application Data
(63) Continuation of application No. 11/653,831, filed on Jan. 17, 2007, now abandoned.
Application No. 11/653,831 is a continuation of application No. 10/883,774, filed on Jul. 6, 2004, now abandoned.

(30) Foreign Application Priority Data
Feb. 9, 2001 (IE) S2001/0125

(51) Int. Cl. B60G 11/56; B60G 11/00

(52) U.S. Cl. 267/34; 280/124.162

(57) ABSTRACT

A suspension system for a vehicle has an upper control arm and an associated lower control arm for mounting a wheel on the vehicle body. A hydro-pneumatic spring is connected between one of the control arms and the vehicle body. A compensating spring is associated with the hydro-pneumatic spring and is operable to act in opposition to the force exerted by the hydro-pneumatic spring as the hydro-pneumatic spring approaches full extension.

This application is a Continuation of co-pending application Ser. No. 11/653,831 filed on Jan. 17, 2007, which is a Continuation of co-pending application Ser. No. 10/883,774 filed on Jul. 6, 2004 and for which priority is claimed under 35 U.S.C. §120; and this application claims priority of Application No. S2001/0125 filed in Ireland on Feb. 9, 2001 under 35 U.S.C. §119; the entire contents of all are hereby incorporated by reference.

### BACKGROUND OF THE INVENTION

1. Field of the Invention

This invention relates to hydro-pneumatic springs and in particular to hydro-pneumatic springs used in vehicle suspension systems.

2. Description of Related Art

A hydro-pneumatic spring uses hydraulic fluid to transmit force to a variable volume gas chamber which acts as a spring. Hydro-pneumatic suspension systems for vehicles offer a number of advantages which include a rise in spring rate as the spring is compressed into bump and the possibility of adding additional features such as integral damping, variable damping, variable ride height, and load compensation. The non-linear spring characteristic, while advantageous as the spring is compressed towards the full bump position, creates a problem as the spring is extended towards the full rebound position because at full rebound, there is usually a large residual force remaining in the spring. This has an adverse effect on vehicle roll when cornering.

The present invention is directed towards overcoming this problem.

### BRIEF SUMMARY OF THE INVENTION

According to the invention, there is provided a suspension system for a vehicle incorporating a hydro-pneumatic spring and an associated compensating spring means which acts in opposition to the force exerted by the hydro-pneumatic spring as said hydro-pneumatic spring approaches full extension.

In one embodiment of the invention there is provided a suspension system for a vehicle, including means for supporting a wheel on a vehicle body, said wheel support means including a hydro-pneumatic spring, a compensating spring means associated with the hydro-pneumatic spring, said compensating spring means being operable to act in opposition to the force exerted by the hydro-pneumatic spring as said hydropneumatic spring approaches full extension.

In one embodiment of the invention there is provided a suspension system for a vehicle, including: an upper control arm, a lower control arm, said control arms for supporting a wheel assembly on a body of the vehicle, each control arm having an inner end and an outer end, the inner end being connected by an articulated joint to the vehicle body, the outer end being connected by an articulated joint to the wheel assembly, a hydro-pneumatic spring having an upper end and a lower end, the upper end being attached to the vehicle body, the lower end being attached to one of said upper and lower control arms, a compensating spring means which is operable as said hydro-pneumatic spring approaches full extension to act in opposition to the force exerted by the hydro-pneumatic spring.

In one embodiment, the compensating spring comprises an elastic element of solid material such as metal or rubber. The compensating spring may conveniently be provided by a coil spring.

In another embodiment, the hydro-pneumatic spring has an oil chamber and an associated gas chamber with a separator piston or membrane therebetween, the spring means acting to reduce the force exerted by the separator piston or membrane on the oil in the oil chamber.

In a preferred embodiment, the compensating spring is a coil spring located within the hydro-pneumatic spring.

In a further embodiment, the compensating spring is mounted externally of the hydro-pneumatic spring and is operable to reduce the force exerted by the hydro-pneumatic spring tending to extend the suspended wheel away from the vehicle body, as said hydro-pneumatic spring approaches full extension.

In another embodiment, the compensating spring is in series with a check strap that limits the extension of the hydro-pneumatic spring.

In another embodiment, the suspension system includes an upper control arm and an associated lower control arm, which locate a wheel with respect to a vehicle body, the hydro-pneumatic spring providing the suspension force tending to extend the suspended wheel away from the vehicle body and one or more compensating springs act between the vehicle body and one or both of the upper and lower control arms to reduce the suspension force as the hydro-pneumatic spring approaches full extension.

In a further embodiment, the compensating spring is a torsion bar.

In another embodiment, the compensating spring is a hydro-pneumatic spring element.

In another embodiment the hydro-pneumatic spring has a suspension actuator which is separate from but operably connected to a hydro-pneumatic element, the suspension actuator having two parts, namely a piston which is slidably mounted within an associated cylinder, one part for connection to the vehicle body and the other part for connection to the wheel support, the hydro-pneumatic element having a chamber containing oil and a chamber containing a gas separated by a separator membrane of piston, an oil chamber within the cylinder formed between an inner end of a bore of the cylinder and the piston, said oil chamber in the cylinder communicating with the oil chamber of the hydro-pneumatic element through a damping orifice.

In a further embodiment the compensating spring means comprises a compensating spring mounted in the oil chamber of the hydro-pneumatic element which acts to reduce the force exerted by the gas on the separator membrane or piston and hence the oil.

In another embodiment a compensating spring is mounted within the cylinder of the suspension actuator on a side of the piston opposite to the oil chamber to resist the force exerted on the piston by oil in the cylinder as the suspension actuator extends.

In another embodiment a second oil chamber is provided on the suspension actuator within the cylinder, said second oil chamber being formed between an outer end of the cylinder bore and the piston, said second oil chamber communicating with a compensating spring means formed by a hydro-pneumatic element comprising a chamber containing a gas and an associated chamber containing oil separated by a separator membrane or piston, the oil chamber of the compensating spring means being connected to the second oil chamber of the suspension actuator.

### BRIEF DESCRIPTION OF THE DRAWINGS

The invention will be more clearly understood by the following description of some embodiments thereof, given by way of example only, with reference to the accompanying drawings, in which:

FIG. 1 is an elevational view illustrating the general arrangement of an independent wheel suspension system incorporating a hydro-pneumatic spring according to the invention,

FIG. 2 is a plan view of the independent suspension system of FIG. 1.

FIG. 3 is a sectional elevational view of a hydro-pneumatic spring of the independent suspension system which incorporates a compensating spring in the form of an internal coil spring,

FIG. 4 is a view similar to FIG. 1 showing the general arrangement of an independent wheel suspension system incorporating a hydro-pneumatic spring and an associated compensating spring according to a second embodiment of the invention, the compensating spring being mounted externally of the hydro-pneumatic spring and in series with a check strap which limits the extension of the hydro-pneumatic spring,

FIG. 5 is an elevational view of the independent suspension system of FIG. 4,

FIG. 6 is a schematic illustration of another hydro-pneumatic spring arrangement showing an arrangement in which a suspension actuator is separate from the hydro-pneumatic spring element and the compensating spring is internal to the hydro-pneumatic spring element and acts to reduce the force exerted by the gas on the oil as the gas volume increases towards its maximum value,

FIG. 7 is a schematic illustration of another hydro-pneumatic spring arrangement showing an arrangement in which the suspension actuator is separate from the hydro-pneumatic spring element and a compensating spring is internal to the suspension actuator and acts to reduce the force exerted by the suspension actuator as it approaches full extension,

FIG. 8 is a schematic illustration of another hydro-pneumatic spring arrangement showing an arrangement in which the suspension actuator is a double-acting hydraulic ram separate from the hydro-pneumatic spring element and the compensating spring is a second hydro-pneumatic spring element connected to the rod end of the suspension actuator and acts to reduce the force exerted by the suspension actuator as it approaches full extension, and

FIG. 9 is a graph illustrating strut characteristics of a hydro-pneumatic spring of the invention.

### DETAILED DESCRIPTION OF THE INVENTION

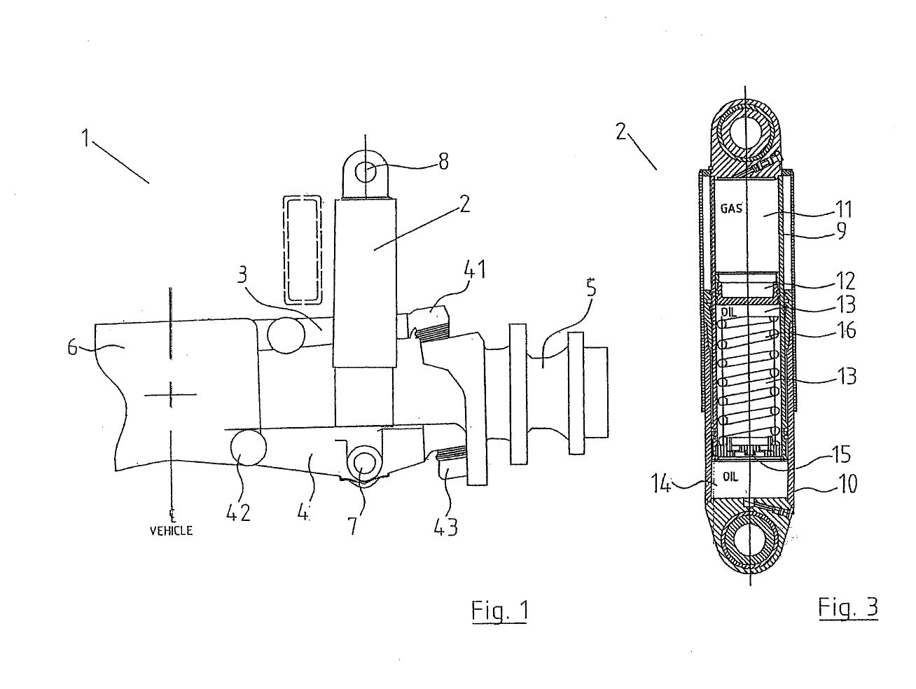

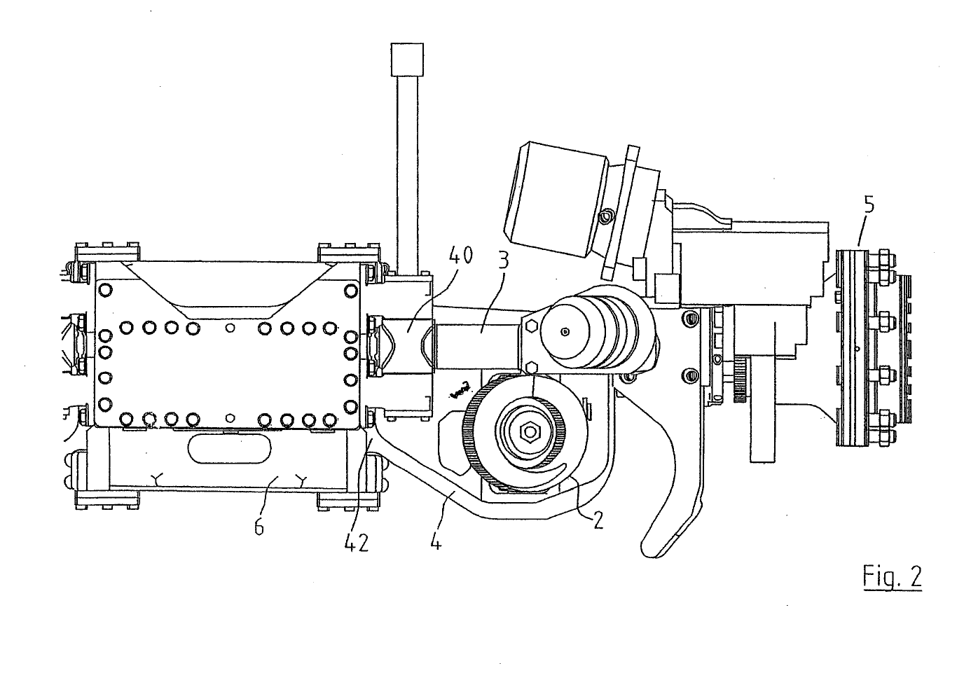

Referring to the drawings, and initially to FIG. 1 thereof, there is illustrated one side of an independent wheel suspension system according to the invention, indicated generally by the reference numeral 1, the other side of the system, which is located at an opposite side of the vehicle, being similar. The suspension system 1 incorporates a hydrostrut, hydraulic suspension actuator or hydro-pneumatic spring 2. In this case, the suspension system incorporates an upper control arm 3 and a lower control arm 4 to locate a wheel carrier 5 with respect to a vehicle body 6. The hydro-pneumatic spring 2 is connected at its upper end to the vehicle body 6 by an articulated joint 8 and at its lower end 7 to the lower control arm 4. It will be understood that this type of suspension system is shown for the purpose of illustration only and that the invention may be used in conjunction with many different types of suspension system. The hydro-pneumatic spring 2 is under compression and provides the suspension force tending to extend the suspended wheel downwardly away from the vehicle body.

Referring to FIG. 3, there is shown a sectional view of the hydro-pneumatic spring 2 according to the invention. The hydro-pneumatic spring 2 comprises an inner cylinder 9, an inner end of which is slidable within an outer cylinder 10. The inner cylinder 9 has an upper chamber containing a variable volume of gas 11 above a separator piston 12. The remaining volume 13 of inner cylinder 9 below the separator piston 12 forms a lower chamber which is filled with oil and communicates with an oil-filled outer cylinder volume 14 through a damper orifice 15. It will be noted that in this embodiment of the invention, a compensating spring 16 is located internally of the inner cylinder 9 within the lower chamber below the separator piston 12. As the hydro-pneumatic spring 2 extends into rebound, the separator piston 12 comes into contact with the compensating spring 16 and begins to compress it. This has the effect of reducing the force exerted by the separator piston 12 on the oil in the hydropneumatic spring 2. The compensating spring 16 free length and stiffness may be chosen to give a hydro-pneumatic spring force which decreases gradually from a suitable load level such as the static load value to zero at full rebound, as shown in FIG. 9.

The upper control arm 3, has an inner end connected by an articulating joint 40 with the vehicle body 6. An outer end of the upper control arm 3 is connected by an articulating joint 41 with the wheel carrier 5 which is a wheel hub on which a wheel (not shown) is mounted. An inner end of the lower control arm 4 is mounted by an articulating joint 42 on the vehicle body 6. An outer end of the lower control arm 4 is connected to the wheel carrier 5 by an articulating joint 43.

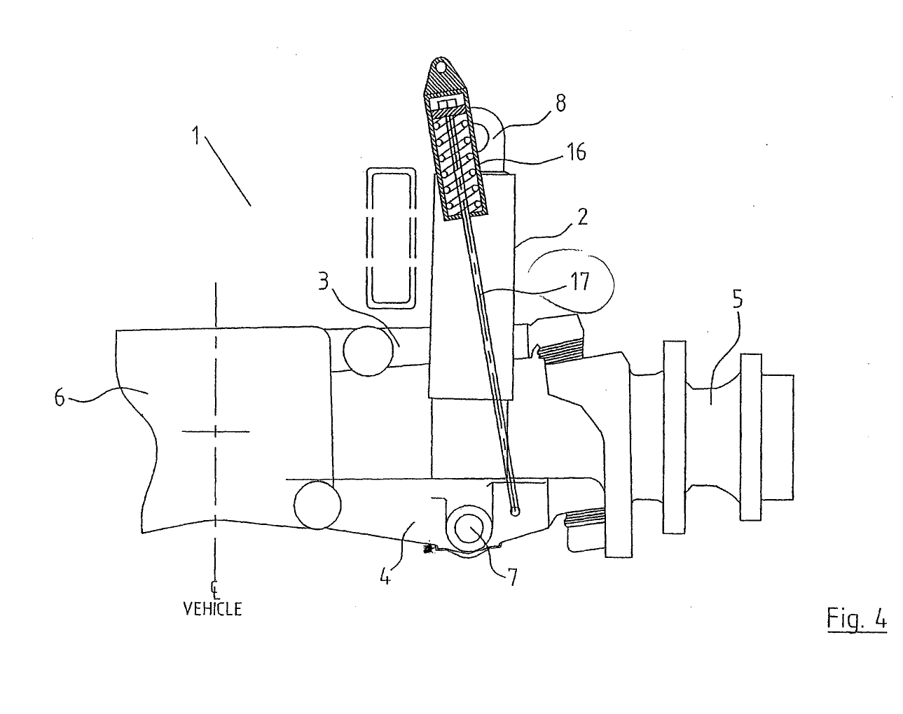

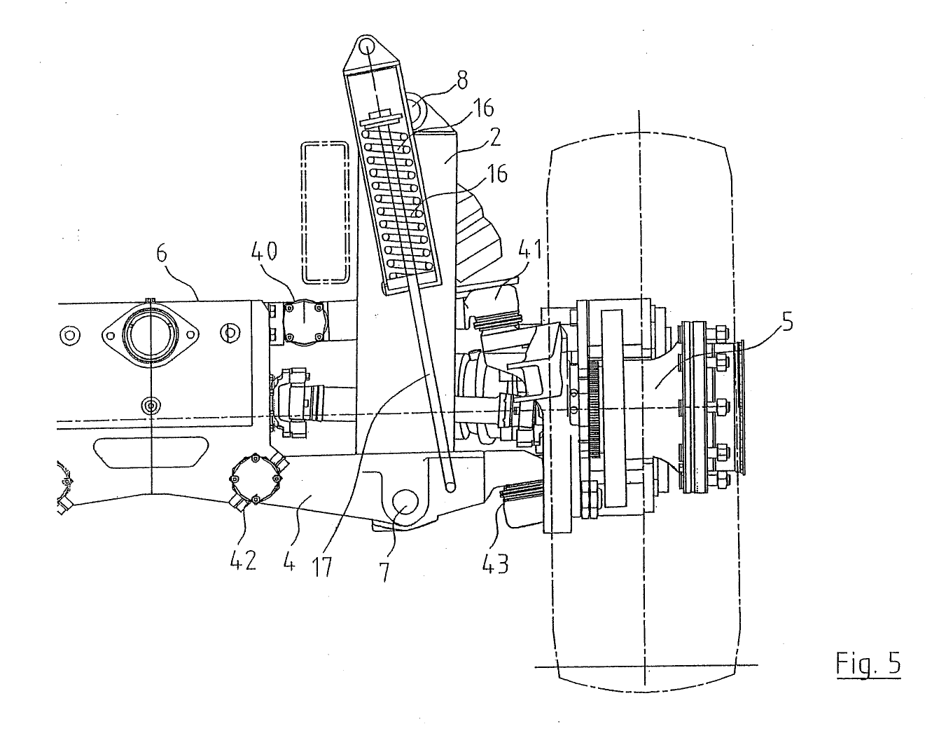

Referring now to FIGS. 4 and 5, there is shown another suspension system which is largely similar to the suspension system shown in FIG. 1 and like parts are assigned the same reference numerals. In this case, a check strap 17 is provided which serves to limit the extension of the hydro-pneumatic spring 2. The check strap 17 is located between the vehicle body 6 and the lower control arm 4. It will be noted that the compensating spring 16 is in this case located externally of the hydro-pneumatic spring 2 and in series with the check strap 17. As the hydro-pneumatic spring 2 extends into rebound, the check strap 17 becomes taut and starts to compress the compensating spring 16. The force in the compensating spring 16 counteracts the residual force in the hydro-pneumatic spring 2. The compensating spring 16 free length and stiffness may be chosen to give a resultant spring force which decreases gradually from a suitable load level such as the static load value to zero at full rebound as shown in FIG. 9.

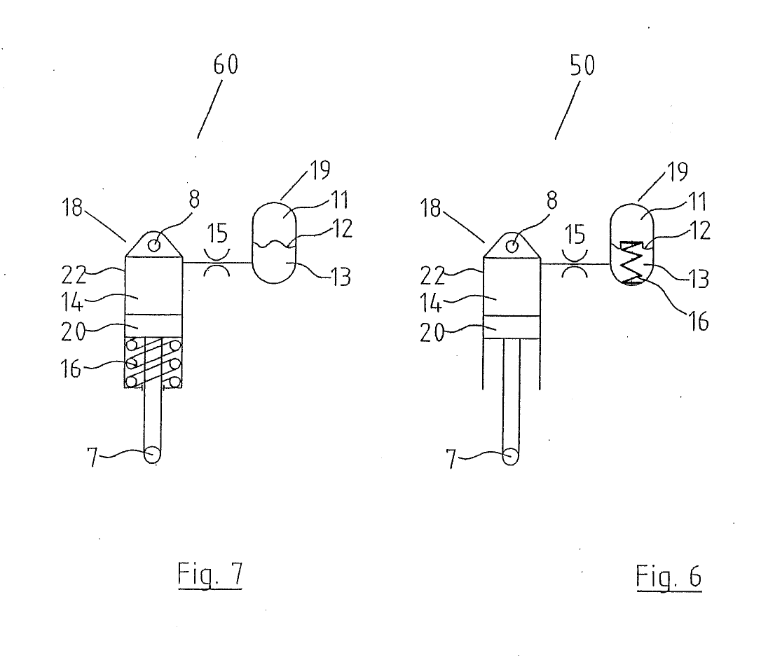

Referring now to FIG. 6, there is shown schematically another construction of suspension system 50 in which parts similar to those described previously are assigned the same reference numerals. In this case, a suspension actuator or strut 18, which is mounted between the body at 8 and the lower control arm 4 at 7, is separate from the hydro-pneumatic spring element 19. The strut 18 has a piston 20 slidable within an associated cylinder 22. An oil chamber filled with an oil volume 14 is formed between an inner bore of the cylinder 22 and the piston 20. The hydro-pneumatic spring 19 is separated into chamber with a gas volume 11 and an associated chamber with oil volume 13 by a separator membrane or piston 12. The oil volume 13 communicates with the oil volume 14 in the suspension actuator or strut 18 through damping orifice 15. The compensating spring 16 is internal to the hydro-pneumatic spring element 19 and acts to reduce the force exerted by the gas on the oil as the gas volume increases towards its maximum value in precisely the same manner as in the embodiment illustrated in FIG. 3.

Referring to FIG. 7, there is shown schematically another embodiment 60 which is largely similar to that of FIG. 6 and like parts are assigned the same reference numerals. However, in this case, the compensating spring 16 is located in the suspension strut 18 within the cylinder 22 beneath the piston 20. The strut piston 20 comes into contact with the compensating spring 16 as the suspension moves into rebound and the force in the compensating spring 16 counteracts the residual force in the suspension strut 18.

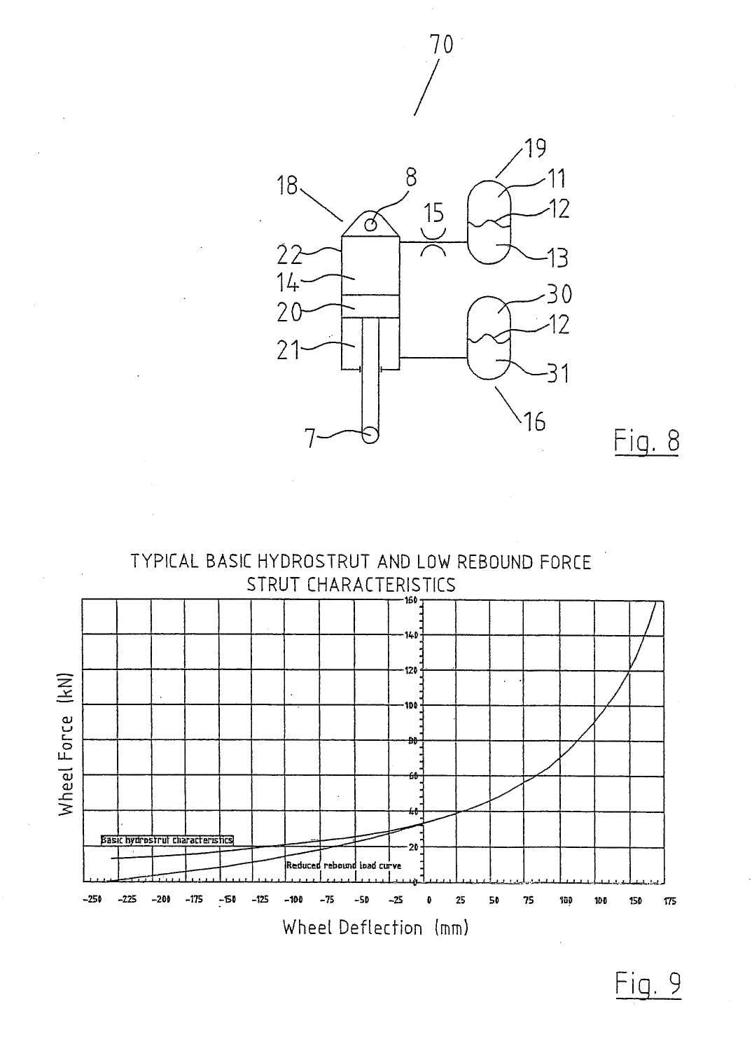

Referring now to FIG. 8, there is shown schematically another suspension system 70 in which parts similar to those described previously are assigned the same reference numerals. In this case, the suspension strut 18 is a double acting hydraulic ram separate from the hydro-pneumatic spring element 19 and the compensating spring 16 is a second hydro-pneumatic spring element connected to a rod end volume 21 of the suspension strut 18 which forms a second oil chamber in the cylinder between the piston 20 and an outer end of the cylinder 22 and acts to reduce the force exerted by the suspension strut 18 as it approaches full extension. The compensating spring 16 has a gas volume 30 and an oil volume 31 separated by a separator membrane or piston 12, the oil volume 31 being connected to the rod end volume 21 of the suspension strut 18.

It will be appreciated that the hydro-pneumatic spring 2 or strut 18, when used in an independent suspension system of the type shown in FIGS. 1 and 4, may be mounted between the vehicle body 6 and either the upper control arm 3 or lower control arm 4. The invention is not limited to the embodiments hereinbefore described which may be varied in both construction and detail within the scope of the appended claims.

1. A suspension system for a vehicle, comprising:
means for supporting a wheel on a vehicle body, said wheel supporting means including a hydro-pneumatic spring, and
a compensating spring means associated with the hydro-pneumatic spring, said compensating spring means being operable to act in opposition to a force exerted by the hydro-pneumatic spring as said hydro-pneumatic spring approaches full extension, wherein:
the hydro-pneumatic spring includes an oil chamber and an associated gas chamber with a separator piston or membrane therebetween, the compensating spring means is located in the oil chamber such that as the hydro-pneumatic spring extends into rebound the separator piston or membrane will compress the compensating spring means, and
the compensating spring means acts to reduce a force exerted by the separator piston or membrane on oil in the oil chamber such that the hydro-pneumatic spring force decreases gradually to zero at full rebound.

2. The suspension system for a vehicle as claimed in claim 1, further comprising:
an upper control arm and
a lower control arm; wherein:
said upper and lower control arms for supporting a wheel assembly on a body of the vehicle, each control arm having an inner end and an outer end, the inner end being connected by an articulated joint to the vehicle body, the outer end being connected by an articulated joint to the wheel assembly,
the hydro-pneumatic spring having an upper end and a lower end, the upper end being attached to the vehicle body, the lower end being attached to one of said upper and lower control arms, and
the compensating spring means which is operable as said hydro-pneumatic spring approaches full extension to act in opposition to the force exerted by the hydro-pneumatic spring.

3. The suspension system as claimed in claim 1 wherein the compensating spring means comprises an elastic element of solid material.

4. The suspension system as claimed in claim 1 wherein the compensating spring means is a coil spring.

5. The suspension system as claimed in claim 1, wherein the compensating spring means is mounted in series with a check strap that limits the extension of the hydro-pneumatic spring.

6. The suspension system as claimed in claim 1, further comprising:
an upper control arm and an associated lower control arm which locate a wheel with respect to a vehicle body, including:
the hydro-pneumatic spring provides a suspension force tending to extend a suspended wheel away from the vehicle body and one or more compensating springs act between the vehicle body and one or both of the upper and lower control arms to reduce the suspension force as the hydro-pneumatic spring approaches full extension.

7. The suspension system as claimed in claim 1, wherein the compensating spring is a torsion bar.

8. The suspension system as claimed in claim 1, wherein the compensating spring is a hydro-pneumatic spring element.

9. The suspension system as claimed in claim 1, wherein the hydro-pneumatic spring has a suspension actuator which is separate from but operably connected to a hydro-pneumatic element, the suspension actuator having a piston which is slidably mounted within an associated cylinder, one part for connection to the vehicle body and the other part for connection to the wheel supporting means, the hydro-pneumatic element having the oil chamber containing oil and the chamber containing a gas separated by the separator piston membrane, an oil chamber within the cylinder formed between an inner end of a bore of the cylinder and the piston, said oil chamber in the cylinder communicating with the oil chamber of the hydro-pneumatic element through a damping orifice.

10. The suspension system as claimed in claim 9, wherein the compensating spring means comprises a compensating spring mounted in the oil chamber of the hydro-pneumatic element which acts to reduce the force exerted by the gas on the separator piston or membrane and hence the oil.

11. The suspension system as claimed in claim 9, wherein a second oil chamber is provided on the suspension actuator within the cylinder, said second oil chamber being formed between an outer end of the cylinder bore and the piston, said second oil chamber communicating with a compensating spring means formed by a hydro-pneumatic element comprising a chamber containing a gas and an associated chamber containing oil separated by a separator membrane or piston, the oil chamber of the compensating spring means being connected to the second oil chamber of the suspension actuator.

12. A suspension system for a vehicle, comprising:
means for supporting a wheel on a vehicle body, said wheel supporting means including a hydro-pneumatic spring; and
a compensating spring means associated with the hydro-pneumatic spring, said compensating spring means being operable to act in opposition to a force exerted by the hydro-pneumatic spring as said hydro-pneumatic spring approaches full extension such that the hydro-pneumatic spring force decreases gradually to zero at full rebound, wherein:
the hydro-pneumatic spring includes an inner cylinder and an outer cylinder,
the inner cylinder has an inner end, said inner end of the inner cylinder being slidable within the outer cylinder,
the inner cylinder has an upper chamber containing a variable volume of gas above a separator piston, and a lower chamber below the separator piston which is filled with oil,
said lower chamber communicates with an oil-filled outer cylinder volume through a damper orifice, and
the compensating spring means is located internally of the inner cylinder within the lower chamber below the separator piston.
